(19) United States
(12) Patent Application Publication
(10) Pub. No.: US 2012/0086197 A1
(43) Pub. Date: Apr. 12, 2012

(54) CONNECTING ELEMENT FOR A FLUID CONNECTION

(75) Inventors: Andreas BAUER, Maintal (DE); Marc RASTETTER, Biebergemuend (DE); Stephan MANN, Biebergemuend (DE)

(73) Assignee: NORMA GERMANY GMBH, Maintal (DE)

(21) Appl. No.: 13/253,551

(22) Filed: Oct. 5, 2011

(30) Foreign Application Priority Data
Oct. 9, 2010 (DE) 102010048107.6

(51) Int. Cl. F16L 37/08; F16L 55/00

(52) U.S. Cl. 285/81; 285/305; 285/93

(57) ABSTRACT

A connecting element for a fluid connection having a housing that includes an insert region structured and arranged to axially receive a plug connector and a latching element, structured and arranged to latch the plug connector, being moveable in relation to the housing via an axial pulling movement between a first position and a second position. The connecting element also includes a safety element. In the second position, the latching element unblocks at least one space that is fillable by the safety element.

### CROSS-REFERENCE TO RELATED APPLICATIONS

The present application claims priority under 35 U.S.C. §119 of German Patent Application No. 10 2010 048 107.6, filed on Oct. 9, 2010, the disclosure of which is expressly incorporated by reference herein in its entirety.

### BACKGROUND OF THE INVENTION

1. Field of the Invention

The invention relates to a connecting element for a fluid connection with a housing having an insert region arranged to axially receive a plug connector. The housing has a latching element provided to latch the plug connector. A safety element is also provided.

2. Discussion of Background Information

Connecting elements of the above-noted type are used to connect two lines, such as, for example, fuel lines or urea lines in a motor vehicle. They can also be used to connect a line to a pipe connection. It is also conceivable to weld the connecting element by one end to a corresponding connection.

The plug connector is formed, for example, by one end of a fluid line or by a pipe connection. As a rule, a plug connector of this type has a perimeter collar, with which the latching element can latch.

In order to obtain a fluid-tight connection, a secure connection of the connecting element to the plug connector is necessary. The assembly is often carried out under time pressure, such as, for example, on conveyor belts. In order to be able to recognize relatively quickly whether the connecting element is properly connected to the plug connector, that is, that the plug connector has been inserted far enough into the insert region and is latched to the latching element, it is known to provide an assembly indicator as a safety element. This assembly indicator can then be moved from a first position into a second position when the plug connector is latched with the latching element inside the housing. A fitter thus cannot move the assembly indicator from the first position into a second position by pressing, for example, until the plug connector is latched in the housing, that is, a secure connection has been produced. The position of the assembly indicator then shows whether a latching has taken place.

The known solutions do not always ensure that a movement of the safety element occurs only when the plug connector is latched in the housing. As a rule, a blocking of the safety element by the plug connector takes place, so that a movement of the safety element is not possible when the plug connector has already been inserted relatively far into the housing without already being latched. However, a movement of the safety element is not prevented before the plug connector has been inserted into the housing. Accordingly, an incorrect operation cannot be ruled out.

In addition, it can occur that a movement of the safety element is also possible when the plug connector is not properly latched, and can thus be released again under tensile force.

### SUMMARY OF THE INVENTION

Embodiments of the invention are directed to a connecting element with which a complete assembly is ensured.

According to the embodiments, a connecting element of the above-described type includes a latching element that can be moved with respect to the housing by an axial pulling movement between the housing and the latching element between a first position and a second position. The latching element in the second position unblocks at least one space, which can be filled by the safety element.

In the first position of the latching element, this space is blocked. The safety element or a part or projection of the safety element cannot engage in the space until a correct assembly has been completed, i.e., only when an axial tensile force has been applied between the latching element and housing. The term “axial” in this context refers to the direction of the symmetry axis of the insert region or in the insert direction of the plug connector. During the assembly, the plug connector is inserted into the insert region of the connecting element until it latches with the latching element. It can also optionally strike against a stop. Through a tensile force, which is generated between the connecting element and the plug connector, i.e., exerted on the connecting element or on the plug connector in the axial direction, an attempt is made to pull the plug connector out of the connecting element again. However, since the plug connector is connected to the latching element, this pulling movement is transferred to the latching element so that the latching element is moved axially relative to the housing. If the latching element is not properly latched to the plug connector, the plug connector is released from the latching element by the tensile force. This is clearly noticeable to the fitter. If the plug connector is properly latched to the latching element, i.e., it has been properly accommodated in the connecting element, the pulling movement between the housing and the plug connector or latching element does not lead to a release of the plug connector. Instead, when the latching element is moved from the first position into the second position, a space for the movement of the safety element is released by this movement. The safety element can thus be moved into the space only when the latching element has been moved axially in the housing by a pulling movement. This pulling movement is transmitted by the plug connector to the latching element. Thus, due to the solution according to the invention, a movement of the safety element occurs only when the plug connector is latched to the latching element, that is, a full assembly has occurred. The safety of the connection between the connecting element and plug connector is thus ensured.

Advantageously, in the second position of the latching element, the safety element blocks an axial movement between the latching element and the housing. When the safety element fills the space and thus indicates that the plug connector is properly latched to the latching element, a further axial movement between the latching element and the housing is not possible, since the safety element prevents the latching element from being pushed back into the space. A relative movement between the connecting element and the plug connector is thus prevented. Instead a stable connection is obtained.

Advantageously, the latching element has at least one elastic latching finger, and preferably two, three or four elastic latching fingers. A latching finger of this type represents a relatively simple way of providing an elastic latching element. Through the elastic embodiment of the latching fingers, no additional joint is necessary. Due to this elasticity, a necessary preloading can also be omitted. Several latching fingers are preferably arranged in a circular manner so that the plug connector can be inserted between the latching fingers, so that the latching fingers are spread by a perimeter collar of the plug connector and latch to the collar after passing through the collar.

It is advantageous if the latching finger has a groove and/or a projection on its radial inside. The projection is used to engage behind the collar of the plug connector to produce a positive connection. The groove is used to accommodate the collar and to produce a positive connection. Through an embodiment of this type, relatively high tensile forces or axial forces can be transferred between the plug connector and the latching element.

Preferably, a deformation of the latching finger in the second position of the latching element is prevented by the housing. The second position of the latching element is achieved only in that the plug connector is properly latched to the latching element and an axial pulling movement has been introduced between the housing and latching element. In the second position of the latching element, not only is the safety element adjustable into the second position, which then prevents a further axial movement between the latching element and the housing, but also a deformation of the latching finger or latching fingers is prevented by the housing. In this way, an accidental release of the plug connector is virtually no longer possible. A release of the plug connector can occur only by moving the safety element back into the first position and subsequently pushing back into the first position. Subsequently, an elastic deformation of the latching fingers is also necessary in order to release the latching between the latching element and the plug connector. Thus, several hand movements are necessary in a specific order in order to remove the plug connector. An accidental release is virtually ruled out.

Preferably, the latching element is arranged inside the housing and can be held positively inside the housing such that only a movement between the first and second position is possible. The latching element is prevented from being lost from the housing. It is also achieved that the axial length of the connecting element is not changed by the movement between the housing and latching element, since the movement of the latching element takes place inside the housing. The latching element is also arranged in a relatively protected manner inside the housing, so that there is no danger of soiling due to environmental influences.

Advantageously, in the region of the latching finger, an opening is arranged in the housing. Further, in the second position of the latching element, one end of the latching finger is covered by the housing. In the case of several latching fingers, the corresponding number of openings must be provided. As a result of the openings in the region of the latching fingers, sufficient space is available for an elastic deformation of the latching fingers, in particular for a radial widening. During the insertion of the plug connector, the latching element being in the first position, the latching fingers can be deformed into the openings. After assembly has been completed, i.e., when the latching element has been pulled into the second position, a deformation of the latching fingers radially outwards is no longer possible, since the ends of the latching fingers are covered by the housing.

Preferably, the latching finger has a projection radially outwards, which extends into the opening. This projection causes a guidance of the latching element in the opening, so that a twisting of the latching element inside the housing is prevented. At the same time, the projection can be used as a stop, by which the movement of the latching element into the second position is limited.

Preferably, the latching finger has a release lever, which extends through the opening. In the case of several latching fingers, each latching finger has a release lever. With the aid of this release lever a pressure can be exerted from outside on the latching fingers such that the ends of the latching fingers are widened radially when the latching element is in the first position. A removal of the plug connector is possible thereby. Since the release levers extend through the openings, easy access from outside is possible.

The release lever is advantageously connected adhesively to the free end of the latching finger. The release lever and the latching fingers or the entire latching element, however, can also be produced in one piece, for example, by an injection molding process.

Preferably, in the first position of the latching element, the release lever projects into the space for the safety element and, in the second position, unblocks the space. The movement of the safety element is thus released or blocked by the release lever(s). At the same time the safety element thereby prevents a movement of the latching element, since it fills the space into which the release lever would have had to be moved. Through this embodiment, it is ensured that a movement of the safety element is not possible until after successful latching of the plug connector inside the connecting element and subsequent application of a pulling movement, which leads to the latching element being displaced axially inside the housing. At the same time, a movement of the latching element back into the housing is prevented by the safety element as soon as it engages into the space and thus indicates a safe connection. An accidental release of the plug connector is thus prevented by the safety element.

In a preferred embodiment, the safety element is embodied or formed as an assembly indicator, which can be moved between a first position and a second position, wherein in the second position of the latching element the space for the movement of the assembly indicator from the first position into the second position is unblocked. The assembly indicator can thus be moved from the first position into the second position only when the latching element is in the second position, i.e., the plug connector is locked properly with the latching element. The assembly indicator can be pressed into the second position by hand, whereby, for example, the space is filled by the assembly indicator. The assembly indicator thus retains its function as a safety element which prevents an axial movement of the latching element in the housing when it has been moved into the second position. The position in which the assembly indicator is located can thereby be clearly recognized from outside. In particular, when a relatively large distance must be overcome between the first position and the second position, the first position of the assembly indicator can be clearly distinguished from the second position. It is therefore discernible at first glance whether the assembly process has been completed or not.

Preferably, the assembly indicator has a base, from which two legs extend, such that the assembly indicator is guided with the legs on the housing. The assembly indicator is thus embodied or formed in a U-shaped manner. During the movement of the assembly indicator from the first position into the second position, the legs are thereby moved into the space that is unblocked by the movement of the latching element from the first position into the second position. Subsequently, the legs are used to prevent a movement of the latching element back into the first position. In this manner, the assembly indicator can be moved, for example, perpendicular to the axial direction.

Preferably, the legs are connected to a bracket on their ends facing away from the base, which bracket in particular is connected by one end via a joint by adhesive force and with the other end via a latching connection. A bracket of this type prevents the assembly indicator from being lost. The bracket can thereby be latched with both legs, for example. However, it is also possible to embody or form the bracket in one piece with the assembly indicator. In this way, a joint by adhesive force is provided between one end and the bracket. An embodiment of this type renders possible a cost-effective production.

Preferably, the legs have a first section which is wider in the axial direction than a second section. The first section in particular begins at the base. Through an embodiment of this type, it is possible for the assembly indicator to engage as it were through the housing to be guided through the legs laterally on the housing. Until the assembly has been completed, that is, the assembly indicator is located in the first position, the assembly indicator is thus guided via the second section on the housing. A movement of the assembly indicator such that the assembly indicator is guided through the first, wider section on the housing is possible only when the corresponding space has been unblocked by the latching element or the release lever. In the transition between the first section and the second section, a step can be provided so that a movement of the latching element from the first position into the second position is prevented by form closure as long as the latching element is in the first position. Through an embodiment of this type, a faulty operation of the assembly indicator is virtually ruled out, a relatively long guide length for the assembly indicator being available at the same time.

Preferably, the width of the first section thereby corresponds to the width of the base. This represents a relatively simple embodiment. At the same time, relatively few edges are necessary.

In a preferred embodiment, the housing has one projection on each side, which engages in a longitudinal recess in the legs of the assembly indicator. Thus through these projections a guide of the assembly indicator takes place during the movement from the first position into the second position. At the same time, the axial position of the assembly indicator is fixed on the housing and the assembly indicator is secured on the housing.

In a further preferred exemplary embodiment, at least two spaces are arranged diametrically opposite one another, so that the safety element in each case in the region of a space has a projection protruding inwards. The safety element can thereby be embodied or formed such that the projections are preloaded radially inwards. With an axial displacement of the latching element into the second position, the projections of the safety element then move automatically into the two spaces that have been unblocked by the latching element. The latching element can then no longer be easily moved back, but is held in its second position. Through the arrangement of the two spaces diametrically opposite one another, a relatively uniform and in particular symmetrical introduction of force thereby occurs.

It is particularly preferred that the safety element has a first ring section that has two sections, in particular flattened sections, arranged diametrically opposite one another on which the projections are arranged and has two curved sections. The curved sections are spaced apart from the housing. Through an embodiment of this type, it is relatively easily possible to preload the projections radially inwards. Through the curved sections spaced apart, an unblocking of the spaces by the projections can be achieved in that the curved sections are pressed radially inwards, e.g., by hand. Due to the distance between the curved sections and the housing there is sufficient space for this. During the radial pushing in of the curved sections, the flattened sections move with the projections radially outwards so that the spaces are unblocked and the latching element can be pushed back into the first position, so that a release of the plug connector is subsequently possible.

Preferably, the safety element has a second ring section, which in particular is held on the housing in a positive manner. Through the ring section, the safety element can be attached to the housing relatively simply in a manner secured against loss. With a positive connection, this second ring section can be elastically deformed for the assembly of the safety element, so that the safety element can be reliably attached to the housing. For this purpose, the second ring section has an interior groove, which interacts, e.g., with a corresponding projection of the housing.

Advantageously, the ring sections are connected to one another via at least two webs, which in particular are arranged on the flattened sections. Between the webs in each case a gap is provided. Due to the webs, an elastic deformation of a ring section is possible without the shape of the other ring section being influenced. Due to the gap at the same time access to the latching fingers or release lever is possible.

Preferably, at least one radial seal is arranged in the housing, in particular in the insert region of the housing. This radial seal can be arranged behind the latching element in the insert direction, that is, further inside the housing. Due to this radial seal, a relatively tight, in particular fluid-tight connection between the plug connector and the connecting element takes place. When the radial seal is arranged spaced further away from the opening of the connecting element than the latching element, it is not impaired during the movement of the latching element occurring during the pulling movement. At the same time, it is arranged inside the connecting element in a relatively protected manner, so that a soiling or damage to the seal is not to be expected.

While one end of the connecting element has the insert region, into which the connector plug can be inserted, the other end of the connecting element can have a welding flange, for example. It is also conceivable to embody the other end of the connecting element as a plug connector or else to embody it just like the first end, that is, likewise to provide it with an insert region. In this case, two latching elements and two safety elements are necessary.

Embodiments of the invention are directed to a connecting element for a fluid connection having a housing that includes an insert region structured and arranged to axially receive a plug connector and a latching element, structured and arranged to latch the plug connector, being moveable in relation to the housing via an axial pulling movement between a first position and a second position. The connecting element also includes a safety element. In the second position, the latching element unblocks at least one space that is fellable by the safety element.

According to embodiments, when the latching element is located in the second position, the safety element can be positionable to block an axial movement between the latching element and the housing.

In accordance with other embodiments, when the latching element is located in the second position, the safety element may be positionable to engage in the at least one space to block an axial movement between the latching element and the housing.

Further, the latching element can include at least one elastic latching finger. The at least one elastic finger may include one of two, three or four elastic latching fingers. The housing can be structured to prevent a deformation of the at least one latching finger in the second position.

According to other embodiments of the instant invention, the latching element may be arranged inside the housing.

In accordance with still other embodiments of the invention, an opening may be formed in the housing in a region of the at least one latching finger. When the latching element is in the second position, an end of the latching finger can be covered by the housing. Further, the at least one latching finger can have a radially outward projection that extends into the opening. The at least one latching finger may have a release lever that extends through the opening.

According to further embodiments of the instant invention, when the latching element is in the first position, the release lever can project into the space for the safety element and in the second position, the release lever can be movable to unblock the space.

Moreover, the safety element can include an assembly indicator that is movable between a first indicator position and a second indicator position, and when the latching element is in the second position, the space for the movement of the assembly indicator from the first indicator position into the second indicator position can be unblocked. The assembly indicator can have a base and two legs extending from the base, the assembly indicator may be guided on the housing. A bracket may be connected on ends of the legs facing away from the base, and the bracket can be connected at one end via a joint by adhesive force and at an other end via a latching connection. The legs have a first section which can be wider in the axial direction than a second section, and the first section begins at the base. Further, a projection is provided in each side of the housing to engage a longitudinal recess in the legs.

In accordance with still yet other embodiments of the present invention, the at least one space can include at least two spaces arranged diametrically opposite one another, and the safety element may include a respective projection protruding inward in a region of the at least two spaces. The safety element may include a first ring section having two flattened sections arranged diametrically opposite one another on which the projections can be arranged and having two curved sections that are spaced apart from the housing. The safety element may include a second ring section, which in particular is held on the housing in a positive manner. Further, the first and second ring sections can be connected to one another via at least two webs, which are arranged on the flattened sections, and a gap may be provided between the webs.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a connecting element of a first embodiment;

FIG. 2 illustrates the connecting element with an inserted plug connector;

FIG. 3 illustrates a side view of the connecting element;

FIG. 4 illustrates a sectional view of the connecting element;

FIG. 5 illustrates a sectional view of the connecting element with inserted connector plug;

FIG. 6 illustrates a three-dimensional representation of a safety element embodied or formed as an assembly indicator;

FIG. 7 illustrates a side view of a second embodiment of the connecting element;

FIG. 8 illustrates a section view of the connecting element according to FIG. 7;

FIG. 9 illustrates a sectional view of the connecting element according to FIG. 7 with inserted connector plug;

FIG. 10 illustrates a second embodiment of the safety element embodied or formed as an assembly indicator;

FIG. 11 illustrates the assembly indicator according to FIG. 10 in closed form;

FIG. 12 illustrates a connecting element of a further embodiment;

FIG. 13 illustrates the connecting element according to FIG. 12 in sectional view;

FIG. 14 illustrates a three-dimensional representation of a safety element; and

FIG. 15 illustrates a sectional view of the safety element according to FIG. 14.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied or formed in practice.

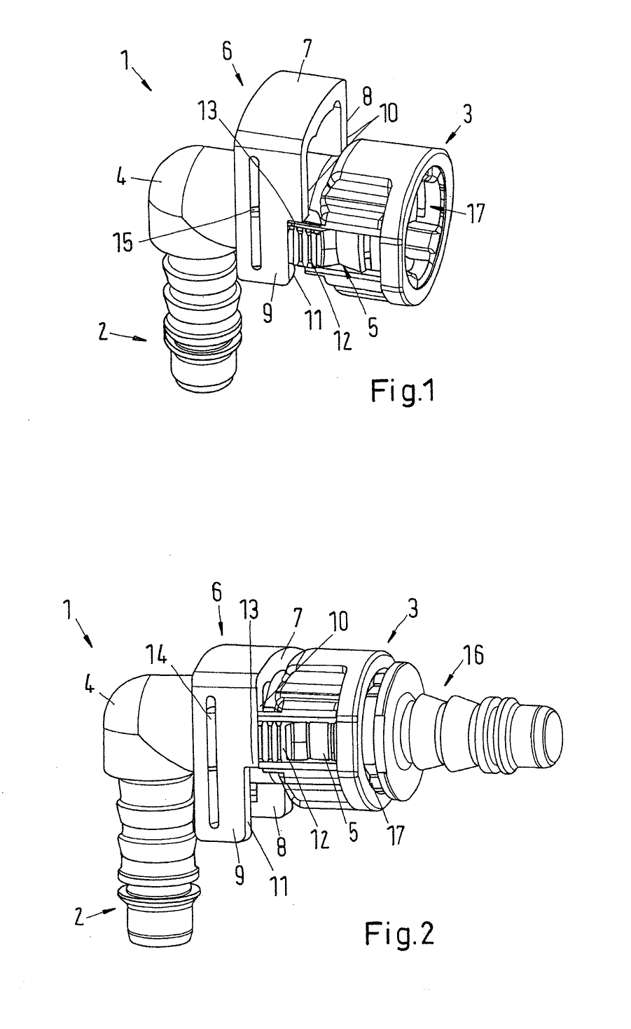

FIG. 1 shows the connecting element 1 in a three-dimensional representation. The connecting element 1 serves to connect two fluid lines and, for this purpose, has on one end a plug-in end section 2 and on another end an insert region 3. A plug connector (not shown in FIG. 1) or a corresponding plug-in end section of a fluid line or of a pipe connection can be axially inserted into insert region 3.

Connecting element 1 has a housing 4, in which a latching element 5 is arranged. Furthermore, a safety element 6 embodied or formed as an assembly indicator is guided on the housing 4. Safety element 6 is embodied or formed in a U-shaped manner. In connection with the description of FIGS. 1 through 11, safety element 6 is referred to below as an assembly indicator, since due to the special embodiment of the safety element in these exemplary embodiments, it is clearly discernible due to its position whether a complete assembly has taken place. Thus, in the discussion of the embodiments, safety element 6 represents an assembly indicator, which will also be designated with reference numeral 6.

Assembly indicator 6 has a base 7 with a leg 8, 9 located on each end that are arranged to extend perpendicular to base 7. Each leg 8, 9 has a first section 10, which is wider in the axial direction than a second section 11. Second section 11 is thereby arranged adjacent to free ends of legs 8, 9, while first section 10 begins on base 7.

In FIG. 1, a plug connector has not yet been inserted into connecting element 1. Accordingly, assembly indicator 6 is in a drawn-out position, which signals that locking has not taken place between latching element 5 and a plug connector. Assembly indicator 6 is thus in its first position. A movement of assembly indicator 6 is prevented by release levers 12 of latching element 5, which project into two spaces which must be unblocked for a movement of assembly indicator 6. The spaces thereby lie diametrically opposite one another and are embodied or formed radially open to the outside. At the same time, a step 13, which is embodied or formed between first section 10 and second section 11, bears against release lever 12 and thus prevents a movement of assembly indicator 6.

With this exemplary embodiment, legs 8, 9 of assembly indicator 6 each have a longitudinal recess 14, into which a projection 15 of housing 4 engages. Through this embodiment, a guidance of assembly indicator 6 during the movement from the shown first position into a second position takes place.

In FIG. 2, a plug connector 16 has now been connected to connecting element 1, i.e., has been inserted into insert region 3 of housing 4. Plug connector 16 has been pushed as far as possible into housing 4 so that a latching of latching element 5 with a peripheral collar of plug connector 16 takes place. Subsequently, an axial pulling movement can be exerted on housing 4 or on plug connector 16, i.e., as if an attempt has been made, as it were, to pull plug connector 16 out of housing 4 again. Latching element 5 has thus been moved axially with plug connector 16 in the direction of an insert opening 17 of housing 4. Release levers 12 of latching element 5 thereby unblock a space for assembly indicator 6 so that it can be moved into the second position, as shown. First section 10 of assembly indicator 6 thereby takes up the space unblocked by the movement of latching element 5. It is therefore not easily possible to move back latching element 5. A movement of assembly indicator 6 from the position shown in FIG. 2 back into the first position shown in FIG. 1 would have to take place.

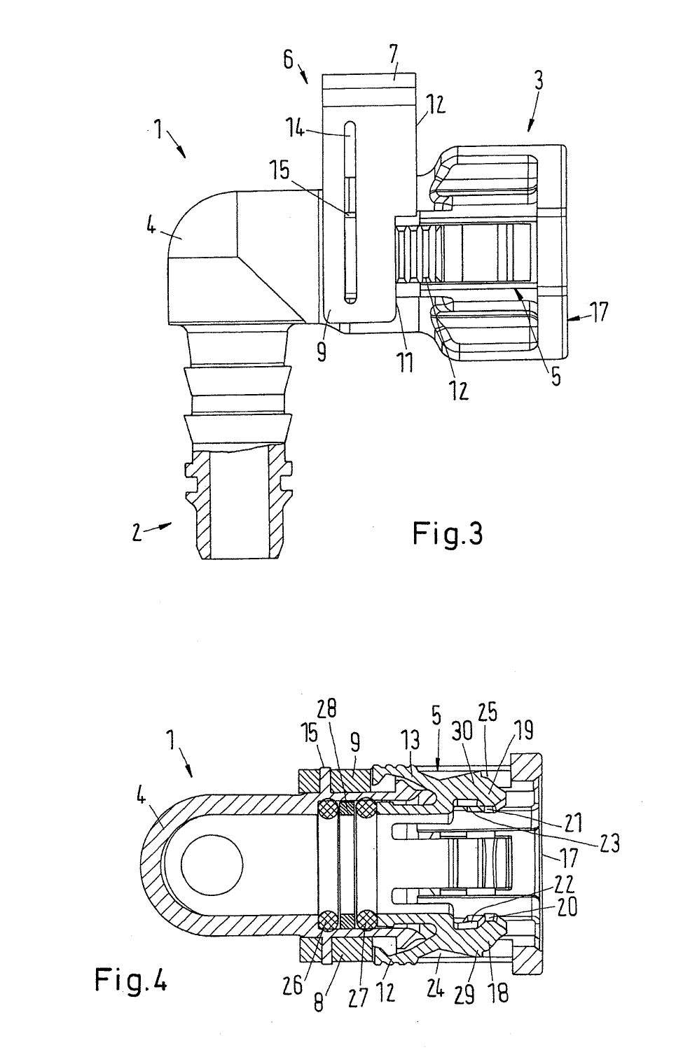

In FIG. 3, connecting element 1 depicted in FIG. 1 is shown in side view. It is discernible that insert region 3 has an enlarged diameter in order to be able to accommodate a plug-in connector.

An embodiment of latching element 5 is shown in FIG. 4. Latching element 5 has a total of four latching fingers 18, 19, of which only two can be seen in the representation shown in FIG. 4. Latching fingers 18, 19 are embodied or formed in an elastic manner and provided on their free ends with projections 20, 21 projecting radially inwards. Projections 20, 21 are each adjoined by a groove 22, 23, which serves to accommodate a collar or ring flange of plug connector 16. When plug connector 16 is inserted into insert region 3 of connecting element 1, latching fingers 18, 19 are pressed radially outwards and thereby move into openings 24, 25 of housing 4. A radial expansion of latching element 5 is thus relatively easily possible.

Release levers 12, 13 are embodied or formed in one piece with latching fingers 18, 19, so that by pressing on release levers 12, 13, the ends of latching fingers 18, 19 are deformed radially outwards. A release of a plug connector inserted into insert region 3 is thus also possible thereby.

Radial seals 26, 27 are arranged inside housing 4 and at a greater distance from insert opening 17 than latching element 5, which radial seals render possible a fluid-tight connection to plug connector 16. A clamping ring 28 is arranged between radial seals 26, 27.

Each of latching fingers 18, 19 has a projection 29, 30, which extends radially outwards into openings 24, 25. These projections 29, 30 serve on the one hand to secure against loss. Latching element 5 cannot thereby be easily removed from housing 4. In addition they are used when with a movement of latching element 5 by a pulling movement, thus in FIG. 4 to the right, the ends of latching fingers 18, 19 come into contact with housing 4 to move latching fingers 18, 19 radially inwards. A secure locking is ensured thereby. Projections 29, 30 can be arranged at the same axial level as grooves 22, 23. Latching fingers 18, 19 then also have an adequate material strength in the region of grooves 22, 23.

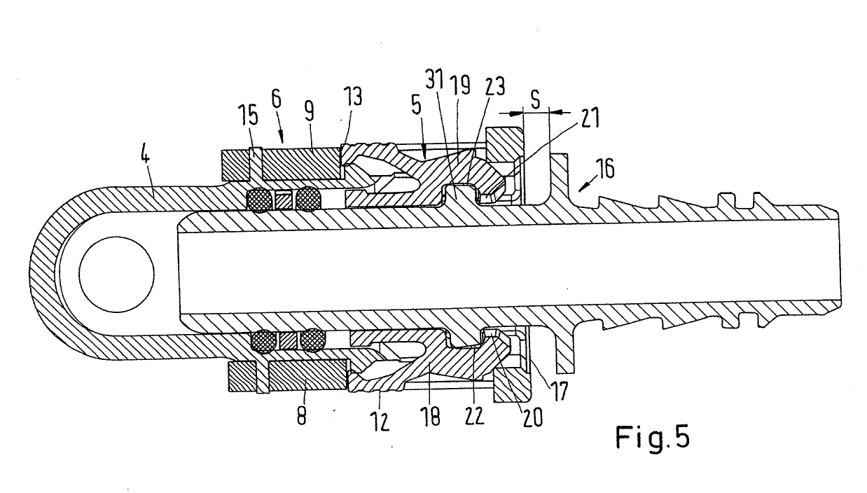

FIG. 5 shows connecting element 1 with inserted plug connector 16. A perimeter collar 31 of plug connector 16 is latched with latching element 1. Perimeter collar 31 is thereby accommodated in grooves 22, 23 of latching fingers 18, 19, wherein projections 20, 21 engage behind perimeter collar 31. Therefore relatively large axial forces can be transferred between latching element 5 and plug connector 16. Through the application of an axial tensile force, plug connector 16 can be drawn out of housing 4 by a distance s, wherein latching element 5 has thereby been moved from a first position by the same distance s, as shown in FIG. 4, into a second position, as shown in FIG. 5. The second position is thereby located axially nearer to insert opening 17. Through this movement of the latching element 5 with respect to housing 4, on two outer sides of housing 4 a space has been unblocked, so that assembly indicator 6 could be pressed into its second position. A difference in the width between first section 10 and second section 11 thereby corresponds to the distance s, by which latching element 5 can be axially moved inside housing 4. First section 10 is now located on a level with release levers 12, 13 of latching element 5. Latching element 5 cannot thereby be pushed into housing 4 again. Since at the same time latching fingers 18, 19 at their ends bear radially outwards on housing 4, in the second position shown of latching element 5, an elastic deformation of latching fingers 18, 9 outwards is not possible. Accordingly, plug connector 16 cannot be removed from housing 4 of connecting element 1.

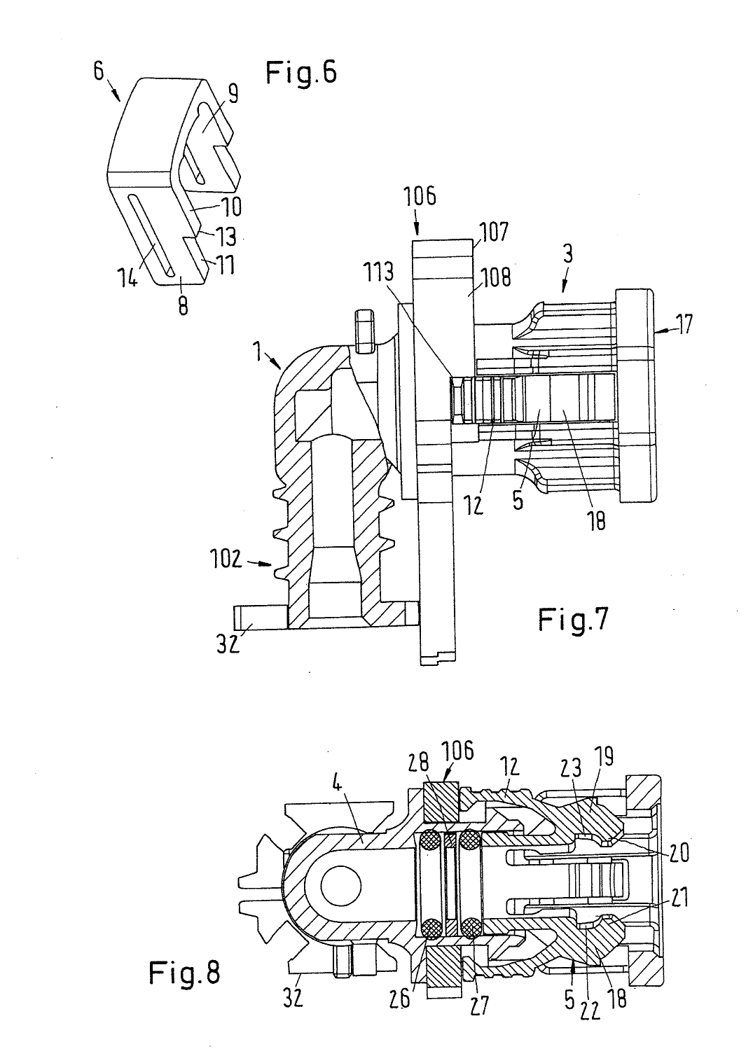

In FIG. 6, assembly indicator 6 is shown individually, as it was used in the exemplary embodiment of FIGS. 1 through 5 and provided with corresponding reference numbers.

FIG. 7 now shows connecting element 1 in a second embodiment, in which same elements are provided with the same reference numbers described in relation to the previously described embodiment, and similar elements are provided with a reference number from the previous embodiment increased by 100.

Connecting element 1, in addition to insert region 3, has an end region 102 with a welding flange 32 that is used to connect connecting element 1 to a fuel tank, for example.

An assembly indicator 106 has two legs 108, 109, which extend in a perpendicular manner from a base 107. Otherwise, connecting element 1 corresponds for example to connecting element 1 in FIG. 3.

FIG. 8 shows a sectional view of connecting element 1 according to FIG. 7, before a plug connector 16 has been inserted into insert region 3. This embodiment corresponds largely to the representation according to FIG. 4, however, instead of plug-in end section 2, an end section 102 with a welding flange 32 has been provided and, instead of the assembly indicator 6, an assembly indicator 106 embodied or formed in a slightly different manner is provided.

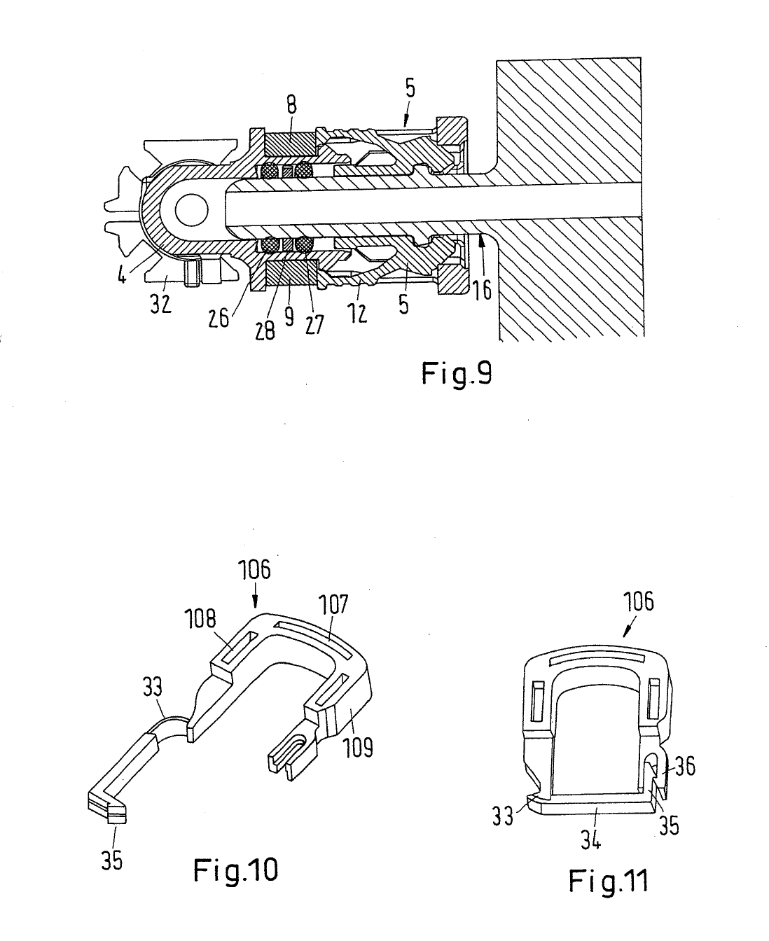

In FIG. 9, connecting element 1 is shown according to FIGS. 7 and 8, wherein a plug connector 16 has been inserted into insert region 3 of connecting element 1 and subsequently an axial force has been exerted between housing 4 and plug connector 16. Latching element 5 has thus been moved from the first position shown in FIGS. 7 and 8 into the second position shown in FIG. 9, so that assembly indicator 106 could be moved from the first position shown in FIGS. 7 and 8 into the second position shown in FIG. 9.

Assembly indicator 106 is shown separately in FIGS. 10 and 11. In FIG. 10, the starting form of assembly indicator 106 is thereby shown. Assembly indicator 106 has a base 107, from which the two U-shaped legs 108, 109 extend. An extension is embodied or formed on leg 108 via a joint 33 by adhesive closure, which extension serves as a bracket 34 in order to connect legs 108, 109 parallel to base 107.

For this purpose, bracket 34 has a latching end 35.

FIG. 11 shows assembly indicator 106 with a closed bracket 34. A corresponding receptacle 36 is provided on leg 109, in order to latch with latching end 35 of bracket 34.

By closing bracket 34, assembly indicator 6 can be held secured against loss on connecting element 1 or on housing 4. With assembly indicator 6, as it is used in the embodiment according to FIGS. 1 through 6, a loss of assembly indicator 6 is prevented by projection 15 in connection with longitudinal recess 14 in legs 8, 9 of assembly indicator 6.

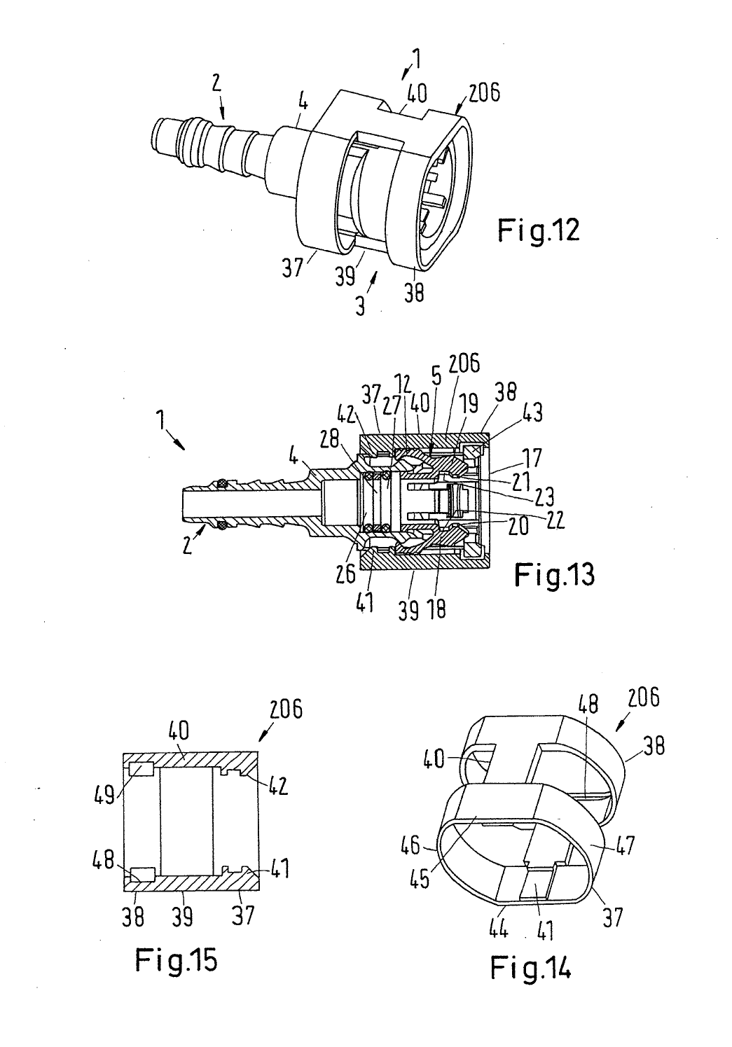

FIG. 12 shows a further exemplary embodiment of the connecting element 1. In this embodiment the plug-in end section 2 and the insert region 3 are aligned with one another, thus are arranged on a common axis. A safety element 206, which like the assembly indicator 6, 106 in the previous exemplary embodiments, is used to prevent an accidental axial movement of the latching element 5 from the second position into the first position, radially surrounds the housing 4 of the connecting element 1. The safety element has a first ring section 37 and a second ring section 38. The ring sections 37, 38 are connected to one another via two webs 39, 40 and arranged parallel to one another in an axially adjacent manner. The safety element 206 is fixed with the second ring section 38 in a positive manner to the housing 4.

The more detailed embodiment of the connecting element is discernible in FIG. 13, in which the same parts are provided with the same reference numbers as labeled in the preceding exemplary embodiments. Safety element 206 has on first ring section 37 projections 41, 42 projecting inwards, which respectively project into an area which is released by release levers 12, since latching element 5 is in the second position in which it is locked to a plug connector, not shown. Projections 41, 42 are thereby embodied or formed such that they prevent an axial return movement of latching element 5 into the first position. For this purpose, in the exemplary embodiment shown projections 41, 42 are respectively embodied or formed in two parts, wherein however a one-part embodiment of the projections is possible.

In the region of second ring section 38, safety element 206 is provided with an internal groove, which interacts with a perimeter flange 43 of housing 4 such that safety element 206 is held on the housing 4 in a positive manner.

FIG. 14 shows safety element 206 separately in a three-dimensional representation. First ring section 37 and the second ring section 38 in each case have two flattened sections 44, 45, which are connected to one another via two curved sections 46, 47. Curved sections 46, 47 thereby represent circular sections of a common circle, while flattened sections 44, 45 form secant lines, as it were. The webs 39, 40 are thereby arranged on respective flattened sections 44, 45 of ring sections 37, 38. Between webs 39, 40, safety element 206 has spaces through which an operation of release levers 12 is possible.

It is discernible that a distance between flattened sections 44, 45 is smaller than a distance between curved sections 46, 47, which respectively lie diametrically opposite one another. Through this embodiment, safety element 206 in the region of flattened sections 44, 45 bears against housing 4 of connecting element 1, while curved sections 46, 47 are spaced apart from housing 4. It is conceivable thereby that safety element 206 or flattened sections 44, 45 bear against housing 4 with a preloading. Through pressure on curved sections 46, 47, flattened sections 44, 45 are radially expanded, so that a distance between flattened sections 44, 45 is thus enlarged. Projections 41, 42 are thereby likewise moved radially outwards and unblock the space that is needed for a movement of latching element 5 from the second position into the first position. It is thereby possible to slide the latching element into a position in which a plug connector can be unlocked.

FIG. 15 shows a sectional representation of safety element 206. It is discernible that projections 41, 42, which are embodied or formed on first ring section 37 and project radially inwards are respectively embodied or formed in two parts. Material can be saved by means of an embodiment of this type.

In second ring section 38 respectively one groove 48, 49 is embodied or formed in order to accommodate a part of flange 43 of housing 4 and thus to hold safety element 206 on housing 4 in a positive manner.

Instead of embodying housing 4 with a perimeter flange 43, it is also conceivable to likewise provide a groove in housing 4 and to use a snap ring, which engages in this groove and into grooves 48, 49 of second ring section 38. The embodiment of housing 4 is simplified as a result, so that at the same time the attachment of safety element 206 is simplified.

Through the embodiment according to the invention thus a connecting element is obtained in which a reliable assembly is ensured. In particular a movement of the safety element or the assembly indicator from a first position into a second position is possible only when a plug connector is locked with the connecting element or the latching element thereof. The safety element or assembly indicator cannot be lost thereby but is held safely on the housing of the connecting element. At the same time a deliberate release of the plug connector is possible without impairing the function of the connecting element. The connecting element can thus be used multiple times.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A connecting element for a fluid connection having a housing comprising:
an insert region structured and arranged to axially receive a plug connector;
a latching element, structured and arranged to latch the plug connector, being moveable in relation to the housing via an axial pulling movement between a first position and a second position;
a safety element,
wherein, in the second position, the latching element unblocks at least one space that is fillable by the safety element.

2. The connecting element according to claim 1, wherein, when the latching element is located in the second position, the safety element is positionable to block an axial movement between the latching element and the housing.

3. The connecting element according to claim 1, wherein, when the latching element is located in the second position, the safety element is positionable to engage in the at least one space to block an axial movement between the latching element and the housing.

4. The connecting element according to claim 1, wherein the latching element comprises at least one elastic latching finger.

5. The connecting element according to claim 4, wherein the at least one elastic finger comprises one of two, three or four elastic latching fingers.

6. The connecting element according to claim 4, wherein the housing is structured to prevent a deformation of the at least one latching finger in the second position.

7. The connecting element according to claim 1, wherein the latching element is arranged inside the housing.

8. The connecting element according to claim 1, wherein an opening is formed in the housing in a region of the at least one latching finger, and
wherein, when the latching element is in the second position, an end of the latching finger is covered by the housing.

9. The connecting element according to claim 8, wherein the at least one latching finger having a radially outward projection that extends into the opening.

10. The connecting element according to claim 8, wherein the at least one latching finger has a release lever that extends through the opening.

11. The connecting element according to claim 1, wherein when the latching element is in the first position, the release lever projects into the space for the safety element and in the second position, the release lever is movable to unblock the space.

12. The connecting element according to claim 1, wherein the safety element comprises an assembly indicator that is movable between a first indicator position and a second indicator position, and
wherein when the latching element is in the second position, the space for the movement of the assembly indicator from the first indicator position into the second indicator position is unblocked.

13. The connecting element according to claim 12, wherein the assembly indicator has a base and two legs extending from the base, the assembly indicator being guided on the housing.

14. The connecting element according to claim 13, wherein a bracket is connected on ends of the legs facing away from the base, and the bracket is connected at one end via a joint by adhesive force and at an other end via a latching connection.

15. The connecting element according to claims 13, wherein the legs have a first section which is wider in the axial direction than a second section, and wherein the first section begins at the base.

16. The connecting element according to claim 13, wherein a projection is provided in each side of the housing to engage a longitudinal recess in the legs.

17. The connecting element according to claim 1, wherein the at least one space comprises at least two spaces arranged diametrically opposite one another, and
wherein the safety element comprises a respective projection protruding inward in a region of the at least two spaces.

18. The connecting element according to claim 17, wherein the safety element comprises a first ring section having two flattened sections arranged diametrically opposite one another on which the projections are arranged and having two curved sections that are spaced apart from the housing.

19. The connecting element according to claim 18, wherein the safety element comprises a second ring section, which in particular is held on the housing in a positive manner.

20. The connecting element according to claim 17, wherein the first and second ring sections are connected to one another via at least two webs, which are arranged on the flattened sections, and
wherein a gap is provided between the webs.
